(19) United States
(12) Patent Application Publication
(10) Pub. No.: US 2020/0372552 A1
(43) Pub. Date: Nov. 26, 2020

(54) PORTFOLIO CHARITABLE GIVING SYSTEM

(71) Applicant: Change Up Inc., Wilmington, DE (US)

(72) Inventor: Robert W. Soderstrom, Los Angeles, MN (US)

(21) Appl. No.: 16/532,874

(22) Filed: Aug. 6, 2019

Related U.S. Application Data
(60) Provisional application No. 62/851,452, filed on May 22, 2019.

(51) Int. Cl. G06Q 30/02

(52) U.S. Cl. CPC G06Q 30/0279; G06Q 2230/00

(57) ABSTRACT

A portfolio charitable giving system is disclosed that includes an individual who can construct a portfolio. The portfolio can include multiple vetted charities set up by a user. The user can also be the donor and at least one of the multiple vetted charities can be changed by the donor or the user. The user can make a contribution to that portfolio. The disclosed charitable giving system can also include rules set up by the donor or user for distributing the charitable donation among the vetted charities in the portfolio in a single step. The rules can be changed by the donor or the user.

### CROSS REFERENCE TO RELATED APPLICATIONS

This application claims the benefit of U.S. Provisional Application Ser. No. 62/851,452 filed on May 22, 2019 which is herein incorporated by reference in its entirety.

### FIELD

The present disclosure relates to applications for electronic devices that enables donors to develop a personal portfolio for charitable giving in an online environment.

### BACKGROUND

Charitable or philanthropic giving has been around for a long time. A main challenge for charitable organizations is to raise funds for their cause. Fund-raising is expensive and requires a significant marketing effort. This is particularly problematic for small, relatively local charities—many of which, although they provide funding to areas popular with charitable donors, may be relatively unknown to them. Additionally, it is difficult for donors or users to give to two or more charities at one time. Typically, the donors need to find each charity on a website and give either a one-time or a recurring donation to each charity. More recently, with the advent of computer technology portable electronic devices such as smart phones and tablets, charitable giving has been facilitated using applications that enable donors to give electronically.

It is known to utilize computer-implemented methods to enable individuals to round-up the monetary end of a purchase to a specified amount and to contribute the difference to a third party. Systems are also known for small investors that allow them to utilize electronic devices to create and manage, on a cost-effective basis, a complex portfolio of securities, based upon the preferences of the investor. These systems can then initiate trades of the portfolio as a whole or in part in order to facilitate the wants and needs of the small investor.

Today, when a potential charitable donor researches a charity on the internet (or by other means), that donor typically visits many different websites collecting information which might not provide answers to them to make informed decisions on their donation. The landscape for charitable giving is fragmented with many single but different ways for the donor to give. In addition, and particularly for local charities (cities, towns, neighborhoods, religious communities, environmental action committees, etc.) it is hard for potential donors to find suitable charities for giving to suit their particular causes or needs.

### SUMMARY

There is a need for systems and methods that allow a philanthropic donor such as a consumer, a business, or a retailer to select multiple charities to be in a charitable portfolio of their choosing. There is a need for a person or user to be able to curate and donate in one place at one time to a single portfolio that holds multiple charities, thus making multiple donations at one time. There is a need to have all of the charities on a uniform platform that can allow for the creation of portfolios, which in turn can receive a single payment and distribute that donation to multiple charities instantaneously. The charitable portfolios can operate like a mutual fund, so that a single donation to that portfolio can be split and simultaneously distributed to each charity in the portfolio. The initial donation can be split in equal or unequal parts to the end charities, depending upon the setting provided by the donor.

A portfolio charitable giving system is disclosed herein that addresses some of these shortcomings for philanthropic donors. A system and method for creating individual customized charitable giving portfolios is disclosed that can provide for charitable contributions in an online social network. More particularly, the disclosed system can allow a donor or user to assemble a portfolio of a limited number of vetted charities, develop rules for the distribution of donations to that portfolio, and to fund the vetted charities that belong to that charitable giving portfolio in a single step according to the rules.

A portfolio charitable giving system is contemplated that includes a donor making a charitable donation to a portfolio. The portfolio can include multiple vetted charities set up by a user. In some embodiments, the user can also be the donor. At least one of the multiple vetted charities can be changed by the donor or the user. The portfolio charitable giving system can also include rules set up by the donor or user for distributing the charitable donation among the vetted charities in the portfolio in a single step, and wherein the rules can be changed by the donor or the user.

In this disclosure,

“circle giving” refers to a group (circle group) of people that come together to determine, as a group, sometimes by a vote, which charities to list in a customized portfolio;

“curator” refers to an entity (that can be the donor) who maintains a charitable portfolio by swapping charities in and out of the portfolio;

“donor” refers to an entity, usually a person, a business, or a school that participates in the disclosed system by donating to a portfolio, helping to set up the portfolio, or changing the portfolio according to rules set up by the donor;

“donor advised fund” refers to a dedicated fund, usually associated with a financial institution, that collects and stores donations to portfolios (and can earn interest or be a charity itself) and then can distribute or split them among charities in the portfolio according to the rules for distribution of donations to portfolios;

“net number of charities” refers to the number of vetted charities available for use in disclosed portfolios;

“rules for distribution of donations to portfolios” refers to predetermined splits with predetermined ratios directions for disseminating funds amassed by donations into the vetted charities contained in a portfolio; and

“vetted charity” refers to a charity that has been determined to not be fraudulent perhaps by using an outside vendor.

The above summary is not intended to describe each disclosed embodiment of every implementation of the present disclosure. The brief description of the drawings and the detailed description which follows more particularly exemplify illustrative embodiments. In the drawings, the layers are not necessarily drawn to scale.

### BRIEF DESCRIPTION OF THE DRAWINGS

The following description should be read with reference to the drawings. The drawings, which are not necessarily to scale, depict examples and are not intended to limit the scope of the disclosure. The disclosure may be more completely understood in consideration of the following description with respect to various examples in connection with the accompanying drawings, in which:

FIG. 1 is a flow diagram of a disclosed process according to the present disclosure.

FIG. 2 is a flow diagram of the same process illustrated in FIG. 1 with an added step wherein the user changes the composition of the members of vetted charities in the portfolio.

FIGS. 3-5 are screen shots of typical screen interfaces of embodiments of the disclosed charitable giving portfolio presented herein.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or sprit of the present disclosure. The following detailed description, therefore, is not to be taken in a limiting sense. Unless otherwise indicated, all members expressing sizes, amounts, and physical properties used in the specification and claims are to be understood as being modified in all instances by the term “about.” Accordingly, unless indicated to the contrary, the numerical parameters set forth in the foregoing application and attached claims are approximations that can vary depending upon the desired properties sought to be obtained by those skilled in the art utilizing the teachings disclosed herein. The use of numerical ranges by endpoints includes all members within that range (e.g., 1 to 5 includes 1, 1.5, 2, 2.75, 3, 3.80, 4, and 5) and any range within that range. The provided system allows for a donor such as a consumer, a business, or a retailer to develop a customized charitable portfolio that can be custom made to their particular interests. The portfolios can be developed by the donor and can be saved in a computer application, such as an app for a smart phone, tablet, or personal computer. The donor can make an initial donation that may be split in equal or unequal parts to the end charities, depending upon the setting provided by the donor. Whenever the donor gives a single donation to a portfolio, the donation can be split and simultaneously distributed to each charity within the portfolio depending upon the rules set up by the donor. For example, the donation can be evenly distributed to all members of a charitable portfolio. Alternatively, the donation can be distributed according to rules set up by the donor. For example, if the portfolio includes five charities, a rule set up by a donor could give 25% of the donation each to three of the charities in the portfolio and then 12.5% of the donation to the remaining two charities of that particular portfolio.

Typically, charities can be selected from a database such as, for example, irs.gov, which currently lists about 850,000 charities that are on their tax-exempt list. The list of charities can be vetted by a third party, by a process that eliminates organizations that engage in criminal, unethical, or otherwise undesirable practices. One exemplary third-party organization that can be used for vetting is the Southern Poverty Law Center. The vetted charities, known as the net number of charities, can then be used by the user or donor to create a personalized portfolio. These can be for national, regional, or local charities such as, for example, listing well-known charity organizations such as the National Audubon Society or the American Cancer Society, lesser known and more localized charities such as the Los Angeles branch of the Humane Society, or very localized charities such as the PTA of a local school. These charities can be selected to create a personalized portfolio for each charitable donator. Other examples of custom portfolios are discussed below.

In another embodiment, a watchdog which is another entity managing a charitable list such as, for example, CHARITY NAVIGATOR, can rank the charities based upon their transparency and effectiveness.

Then, a curator (e.g., an individual, a donor, a user, a club, a retailer, a brand, etc.) can build a portfolio of two or more charities. As an example, the curator can create, for example, a “portfolio to fight climate change” that includes 10 charities that are all committed to environmental matters. A donor can then give an initial donation to a selected portfolio. The initial donation lands in a donor advised fund, that is itself a charity. The donor advised fund then distributes the donation to the individual members of the portfolio according to preset rules. For example, if the donor gives as an initial donation ten dollars to that portfolio, one dollar will be distributed to each charity in that portfolio if the rules of that portfolio allow for equal distribution of all donations. In another example, the donor may dictate that one charity receive 50% of the initial donation, another charity 25%, and the remaining 25% evenly split between the remaining eight charities.

The donor may curate his individual charitable portfolio at any time by swapping charities in and out of the portfolio. For example, in moments of national disaster, all charities could be replaced by one such as the American Red Cross. Or, at the end of each month, two of ten charities could be replaced by two new charities and the new charities rotated into the charitable portfolio with the oldest one rotated out.

Typically, each charitable portfolio can have from two to an unlimited number of charities. However, it is contemplated that, for use on a personal electronic device, the number of charities in a portfolio be limited to from about 2 to about 20 charities, more typically between about 3 and 15 charities, and even more typically from between 5 and 10 charities.

In some embodiments, groups of people can join the software to vote on which charities should be included in a portfolio for a set time period, such as a month. For example, members of a giving club of employees at a business can vote each month for 5 charities to be in that business' portfolio. The 5 charities can be rotated in order listed on an app or even rotated in or out of the portfolio by the choice of different people or departments in the business. In some embodiments, a charitable giving committee could influence the members of the portfolio.

In another embodiment, each charitable portfolio can benefit from a social media audience that also makes donations and, optionally, votes on the contents of that portfolio. For example, members of a social media audience who have subscribed to follow a person or an entity that is curating a particular charitable portfolio can also donate to the charitable portfolio at any time. In some embodiments, the person curating the charitable portfolio could become a celebrity of sorts because of the inspiration surrounding the curation of the charitable portfolio. In other embodiments, in order to attract charitable contributions, the curator can be or can be associated with a well-known individual or celebrity.

An exemplary possible flow of a process according to this disclosure could proceed as outlined herein. In this example, the term, “user”, is being used to represent a donor or curator or groups that donate or curate. In this example, a user can choose from a list of charities in a vetted database. The user can choose a charity by name, taxID, location (city, state, ZIP), category (e.g. pets, climate, religion), or any other attribute. The charities can be listed as a part of an electronic device application (or, app) by the organizer of the customized charitable giving system. The user can choose a defined number, N, of charities to be a part of his or her customized charitable portfolio.

Next, the user can choose how donations are split. For example, in one embodiment, each of the N charities in the customized charitable portfolio can split the donations evenly with each of the N charities receiving 1/N of the donations. Alternatively, in another embodiment, the customized charitable giving system manages charitable portfolios that can have predetermined splits with predetermined ratios as discussed above based upon the user's preference. In yet another embodiment, the user can choose custom percentages for each charitable member of the charitable portfolio as long as all of the percentages add up to 100%. In some embodiments, the user or donor can change the members of the portfolio by adding or deleting other vetted charities to the portfolio. In some embodiments, the user or donor can change the members of the portfolios only with permission of one or more other users or donor. In this embodiment, the members of the portfolio remain the same unless appropriately changed. In some embodiments, the distribution rules can be changed by the user or donor only with the permission of one or more other users. In this embodiment, the rules for distribution of donations within the portfolio remain the same unless appropriately changed.

In some embodiments, changes to either the members of the charitable giving portfolio or the distribution rules for distributing charitable contributions amongst the member of the portfolio can be made by any user or donor. In some embodiments, the changes can be made online by the user or donor using a smart device or a personal or central computer. In other embodiments, only a designated user or donor may have permission to change either the members of the portfolio or the rules for distributing funds. In some embodiments, the portfolio can be managed by a charitable giving organization according to the rules set up by that organization. This can include the members of the portfolio and/or the rules for distribution of donations amongst the members of the portfolio.

In some embodiments, the system can include scheduled, regular, donations into the portfolio (along with distribution to the charity members of the portfolio according to the rules). In this embodiment, for example, a monthly withdrawal from a set monetary account of a donor can be facilitated by the system. In other embodiments, a one-time withdrawal of a custom monetary account can be facilitated.

The users can assign a name to a charitable giving portfolio. For example, a charitable giving portfolio can be named, “Clean Water for All”, “Company ABC Giving Fund”, or “Soccer Saves Lives”. The disclosed portfolio charitable giving system can then assign a unique systemwide ID to the portfolio that includes immutable fields such as the “creator” (the user the built the portfolio), the creation date, as well as fields set up by the user such as which charities are included in the portfolio, the splits between the charity when charitable donations are made, the name of the donor, and the edit date of the portfolio. A database maintains audits so the lifecycle of the portfolio can be encoded, and the system can make queries of the portfolio history (for example, what charities and splits were in the portfolio two months ago). The users can revisit any step in the process and edit any setting such as the splits, portfolio name, charities included, but the system ID remains the same. Typically, the funds for each charitable giving portfolio are stored in a donor advised fund that can collect the funds and, upon request, or after a predetermined time period, can transfer the assets of each charitable fund to the appropriate account of each individual charity.

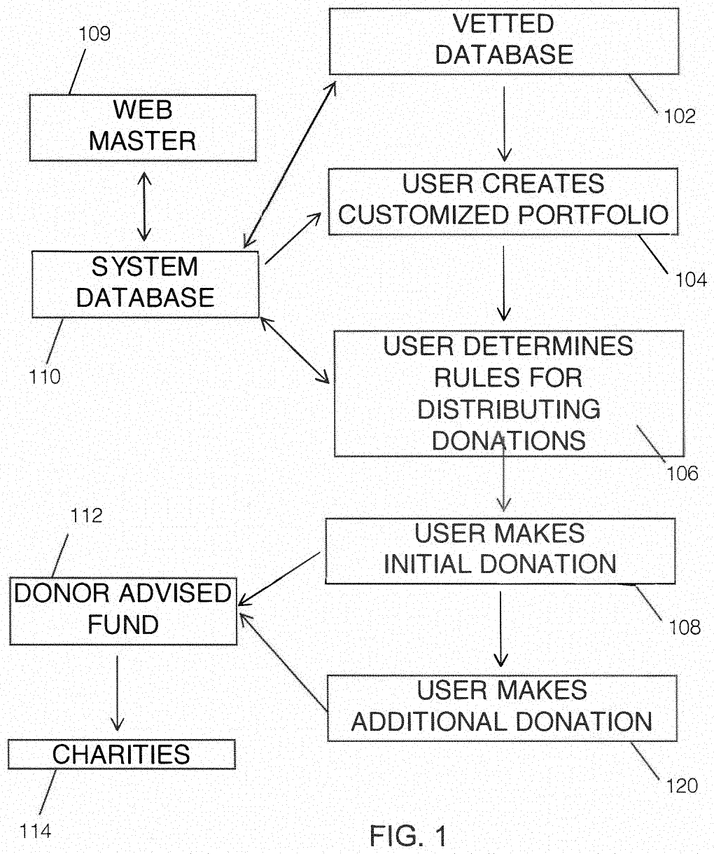

FIG. 1 is a flow diagram of an embodiment of a disclosed process according to the present disclosure. In FIG. 1, a web-based app is associated with system database 110 maintained by web master 109. The web master can be the user, a service contracted by the user, a service contracted by a charity, or an entity in the business of maintaining websites for charitable entities. System database 110 contains an assortment of vetted databases 102 that may be of interest to a user when assembling a customized charitable giving portfolio. Vetted database 102 is maintained in system database 110 and is available to a user for creating a portfolio. The user creates a customized portfolio 104 of individual charities from vetted database 102 according to his or her interests. Typically, such a customized portfolio includes from about 3 to about 20 charities—many of which may be local and small charities. The user then determines rules 106 for splitting any received donations to the portfolio among the various vetted charities in the portfolio. To start the customized charitable portfolio, the user makes an initial donation 110 to the charity via donor advised fund 112 in which the contribution is held and eventually dispersed to charities 114 according to rules 106. This dispersion can happen on a scheduled basis or upon request of the user or web master or any other authorized party. If desired, the user can then make an additional donation 120.

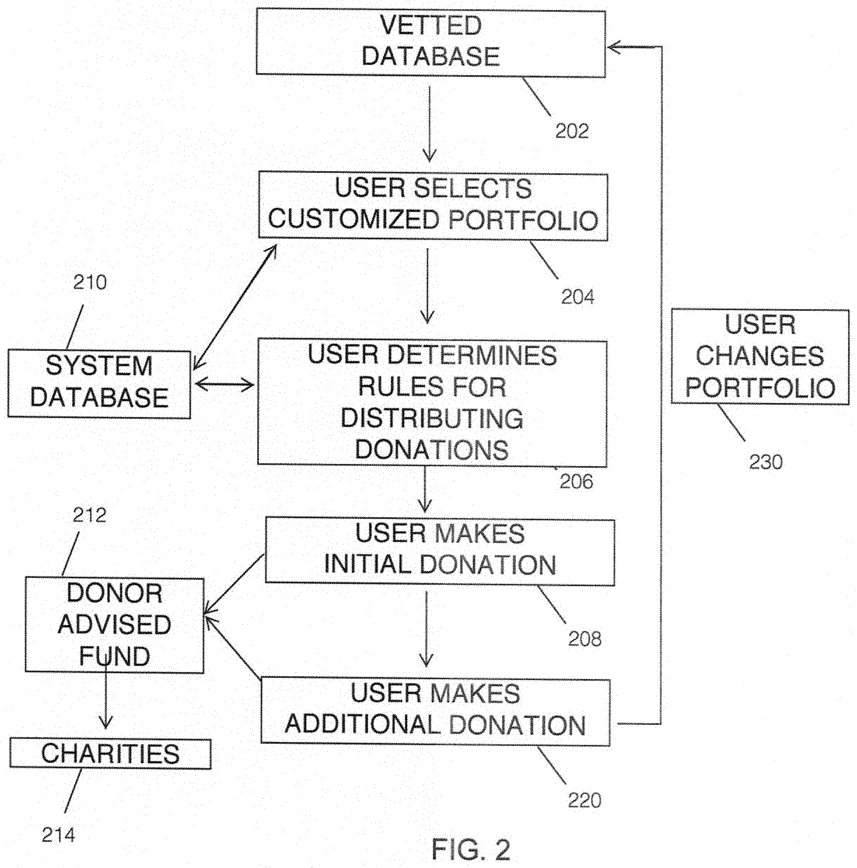

FIG. 2 is a flow diagram of the same process shown in FIG. 1 except, in a further step, the user changes the composition of the members of vetted charities in the portfolio. In FIG. 2, a web-based app is associated with system database 210. System database 210 contains an assortment of vetted databases 202 that may be of interest to a user when assembling a customized charitable giving portfolio. Vetted database 202 is maintained in system database 210 and is available to a user for creating a portfolio. The user selects a customized portfolio 204 of individual charities from vetted database 202 according to his or her interests. Typically, such a customized portfolio includes from about 3 to about 20 charities—many of which may be local and small charities. The user then determines rules 206 for splitting any received donations to the portfolio among the various vetted charities in the portfolio. To start the customized charitable portfolio, the user makes an initial donation 208 to the charity via donor advised fund 212 in which the contribution is held and eventually dispersed to charities 214. This dispersion can happen on a scheduled basis or upon request of the user or web master or any other authorized party. If desired, the user or donor can make additional donation 220 via donor advised fund 212. If desired, user or donor can change the portfolio 230.

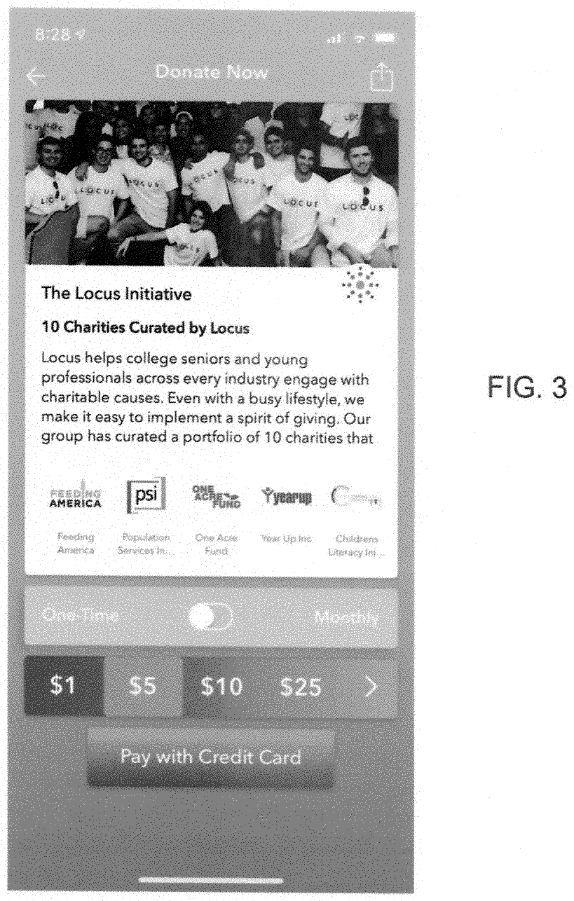

FIGS. 3, 4, and 5 are screen shots of typical screen interfaces of embodiments of the disclosed charitable giving portfolio presented herein. FIG. 3 is a screen shot of a web interface of a portfolio curated by Locus, an organization that helps college seniors and young professionals across every industry engage with charitable causes. The portfolio comprises ten charities, five of which are listed on the screen face. This is an example of circle giving.

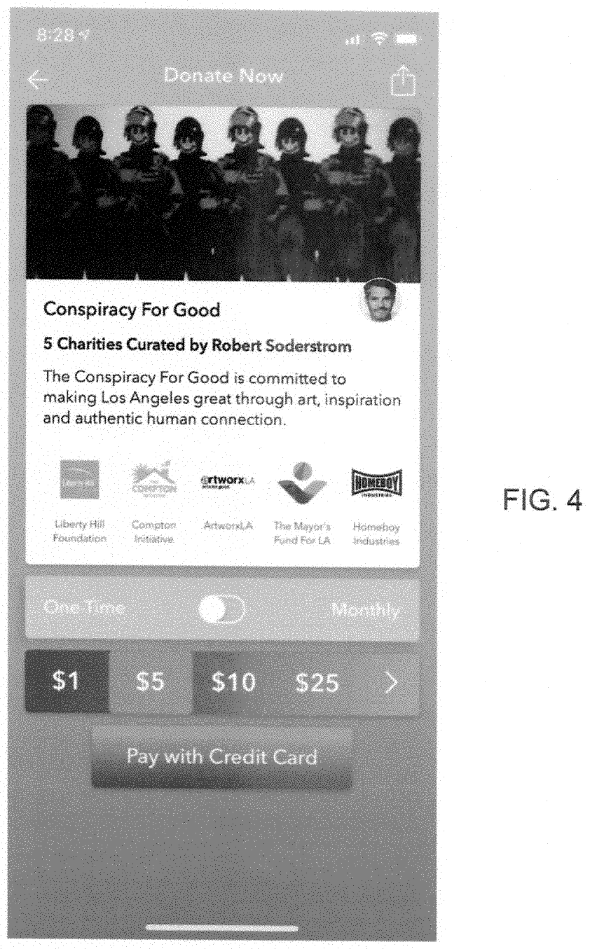

FIG. 4 is a screen shot of a web interface of a portfolio that includes five charities curated by Robert Soderstrom and is called “Conspiracy for Good”. This charity is local to Los Angeles and is committed to make Los Angeles great through art, inspiration and authentic human connection. This portfolio is comprised of five charities that are listed on the screen face.

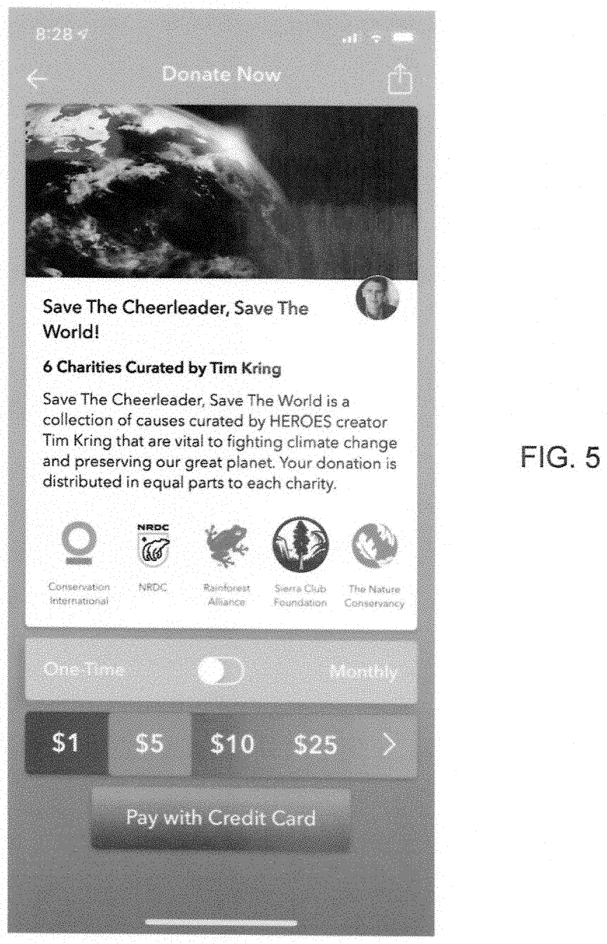

For example, the screen shot illustrated in FIG. 5 shows a portfolio that includes six charities and is entitled, “Save the Cheerleader, Save the World!” A brief description of the portfolio (collection of causes) is presented. In the instant case, the “Save the World” portfolio is curated by HEROES creator Tim Kring and the rules of the portfolio are listed by disclosing that your donation is distributed in equal parts to each charity. Five of the six charities are listed on the front interface screen along with contribution possibilities for a donor or user.

Various modifications and alterations to this disclosure will become apparent to those skilled in the art without departing from the scope and spirit of this disclosure. It should be understood that this disclosure is not intended to be unduly limited by the illustrative embodiments set forth herein and that such embodiments are presented by way of example only with the scope of the disclosure intended to be limited only by the claims set forth herein as follows. All references cited in this disclosure are herein incorporated by reference in their entirety.

What is claimed is:

1. A portfolio charitable giving system comprising:
a donor making a charitable donation to a portfolio;
a portfolio comprising multiple charities set up by a user,
wherein the user can also be the donor, and
wherein at least one of the multiple charities can be changed by the donor or the user; and
rules set up by the donor or user for distributing the charitable donation among the charities in the portfolio in a single step,
wherein the rules can be changed by the donor or the user.

2. A portfolio charitable giving system according to claim 1, wherein the portfolio stored in a system database.

3. A portfolio charitable giving system according to claim 2, wherein a web-based app is associated with the system database.

4. A portfolio charitable giving system according to claim 1, wherein the multiple charities are vetted by a third party.

5. A portfolio charitable giving system according to claim 4, wherein the third party uses a process that eliminates organizations that engage in criminal, unethical, or undesirable practices.

6. A portfolio charitable giving system according to claim 1, wherein the portfolio comprises a personalized portfolio for the donor.

7. A portfolio charitable giving system according to claim 1, wherein a watchdog managing a charitable list ranks the charities based upon transparency and effectiveness.

8. A portfolio charitable giving system according to claim 1, wherein the user is a curator.

9. A portfolio charitable giving system according to claim 8, wherein the curator comprises an individual, a donor, a user, a giving club of employees, a retailer, or a brand.

10. A portfolio charitable giving system according to claim 1, wherein the user swaps charities in and out of the portfolio.

11. A portfolio charitable giving system according to claim 1, wherein the system is accessed by a portable electronic device.

12. A portfolio charitable giving system according to claim 11, wherein the portable electronic device comprises a smart phone, a smart tablet, or a portable computer.

13. A portable charitable giving system according to claim 9, wherein a giving club votes for the charities in the portfolio.

14. A portable charitable giving system according to claim 1, wherein the system comprises scheduled, regular, donations into the portfolio.

15. A method of making donations comprising:
creating a charitable portfolio from multiple vetted charities;
developing rules for distribution of donations among the vetted charities in the portfolio;
storing the charitable portfolio and rules for distribution of donations in a system database;
making an initial donation to the charitable portfolio,
wherein the initial donation is stored in a donor advised fund;
optionally, making additional donations to the charitable portfolio wherein the additional donations are stored in the donor advised fund;
the donor advised fund distributing the initial and, if applicable, additional donations to the charities in the portfolio according to the rules for distribution of donations to the vetted charities in the portfolio stored in the system database.

16. A method of making donations according to claim 15, wherein one or more of the vetted charities, the portfolio, or the rules for distribution of donations are stored in the system database.

17. A method of making donations according to claim 15 further comprising changing the vetted charities in the portfolio.
